(19) United States
(12) Patent Application Publication
(10) Pub. No.: US 2024/0248685 A1
(43) Pub. Date: Jul. 25, 2024

(54) PROGRAM GENERATION APPARATUS, PROGRAM GENERATION METHOD AND PROGRAM

(71) Applicant: NIPPON TELEGRAPH AND TELEPHONE CORPORATION, Tokyo (JP)

(72) Inventors: Toshiyuki KURABAYASHI, Tokyo (JP); Yu YOSHIMURA, Tokyo (JP); Haruto TANNO, Tokyo (JP)

(73) Assignee: NIPPON TELEGRAPH AND TELEPHONE CORPORATION, Tokyo (JP)

(21) Appl. No.: 18/558,200

(22) PCT Filed: May 13, 2021
(86) PCT No.: PCT/JP2021/018183

§ 371 Date: Oct. 31, 2023

(51) Int. Cl. G06F 8/30

(52) U.S. Cl. CPC G06F 8/30

(57) ABSTRACT

A program generation device includes a calculation unit that calculates, for a plurality of first source codes, a similarity between the first source code and a sentence explaining a specification of a desired program in a natural language, and calculates an attention degree of each token constituting the first source code in calculation of the similarity, and a generation unit that generates a plurality of synthesis codes by synthesizing a token having a relatively high attention degree among the first source codes having a relatively high similarity with a second source code prepared in advance, thereby improving a probability that a desired program is generated.

### TECHNICAL FIELD

The present invention relates to a program generation device, a program generation method, and a program.

### BACKGROUND ART

In recent years, the shortage of IT personnel has become a major problem while the spread of IT in the entire society has progressed. According to estimates by the Ministry of Economy, Trade and Industry, it is predicted that there will be a shortage of about 360,000 IT personnel in 2025. In particular, the shortage of IT personnel in an implementation process requiring specialized knowledge is an urgent problem, and there is a demand for research and development of an automatic programming technology for performing automatic programming.

In the related art, there is a method of automatically generating a program by using two pieces of information of a natural language describing a specification of a program to be generated and an input/output example (Non Patent Literature 1). In Non Patent Literature 1, first, a similar program is searched for from a natural language to acquire the similar program. Subsequently, the program synthesis is performed based on the program so as to satisfy the input/output example, and the program is automatically generated. As an advantage of Non Patent Literature 1, since the program synthesis is performed using the program assumed to be similar to the correct program acquired by the search as a template, it is difficult to generate an overfitted program as compared with a program generation method using only the input/output example.

### CITATION LIST

### Non Patent Literature

Non Patent Literature 1: Toshiyuki Kurabayashi et al., “Automatic Program Generation Using Deep Learning and Genetic Algorithms”, Proceedings of Software Engineering Symposium 2020, [online], Internet <URL: https://ipsj.ixsq.nii.ac.jp/ej/index.php?active_action=repo sitory_view_main_item_detail&page_id=13&block_id=8&item_id=206745&item_no=1>

### SUMMARY OF INVENTION

### Technical Problem

However, since the program synthesis is a technique of randomly combining program components so as to satisfy the input/output example, even in a case where a program similar to the correct program is used as a template, there is a likelihood that the token that should not be changed in the template is also changed, and in that case, there is a likelihood that the correct program (desired program) cannot be generated.

The present invention has been made in view of the above points, and an object thereof is to improve a probability of generating a desired program.

### Solution to Problem

Therefore, in order to solve the above problem, a program generation device includes: a calculation unit that calculates, for a plurality of first source codes, a similarity between the first source code and a sentence explaining a specification of a desired program in a natural language, and calculates an attention degree of each token constituting the first source code in calculation of the similarity; and a generation unit that generates a plurality of synthesis codes by synthesizing a token having a relatively high attention degree among the first source codes having a relatively high similarity with a second source code prepared in advance.

### Advantageous Effects of Invention

It is possible to improve a probability of generating a desired program.

### BRIEF DESCRIPTION OF DRAWINGS

FIG. 1 is a diagram illustrating an example of a hardware configuration of a program generation device 10 according to an embodiment of the present invention.

FIG. 2 is a diagram illustrating an example of a functional configuration of the program generation device 10 according to the embodiment of the present invention.

FIG. 3 is a flowchart for describing an example of a processing procedure of learning processing of a similarity calculation model m1.

FIG. 4 is a diagram illustrating an example of a search data set.

FIG. 5 is a diagram for describing learning of the similarity calculation model m1.

FIG. 6 is a flowchart for describing an example of a processing procedure of automatic generation processing of a program.

FIG. 7 is a diagram illustrating an example of a target explanatory sentence.

FIG. 8 is a diagram illustrating a state of searching for a similar code.

FIG. 9 is a diagram illustrating an example of generating a template.

FIG. 10 is a diagram illustrating an example of an input/output example set.

FIG. 11 is a diagram illustrating an example of a program component list.

FIG. 12 is a diagram illustrating an example of a synthesis code generated using a template.

### DESCRIPTION OF EMBODIMENTS

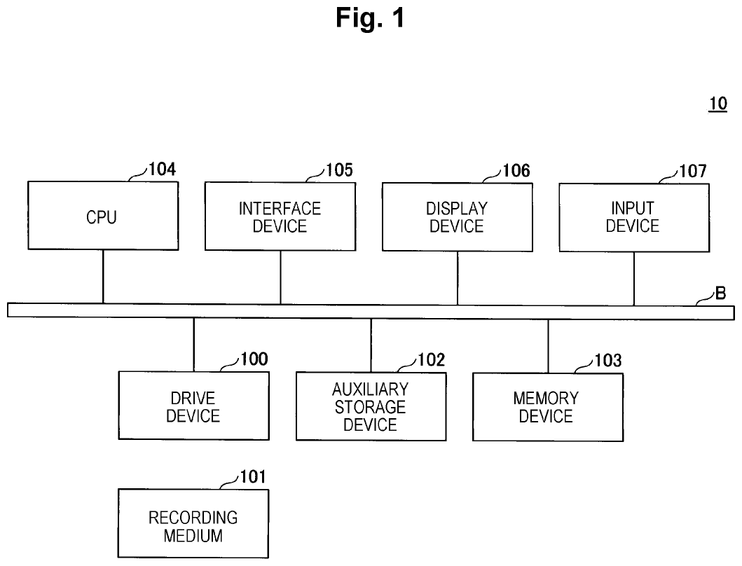

Hereinafter, embodiments of the present invention will be described with reference to the drawings. FIG. 1 is a diagram illustrating an example of a hardware configuration of a program generation device 10 according to an embodiment of the present invention. The program generation device 10 illustrated in FIG. 1 includes a drive device 100, an auxiliary storage device 102, a memory device 103, a CPU 104, an interface device 105, a display device 106, an input device 107, and the like, which are connected to each other via a bus B.

A program for implementing processing in the program generation device 10 is provided by a recording medium 101 such as a CD-ROM. When the recording medium 101 storing the program is set in the drive device 100, the program is installed on the auxiliary storage device 102 from the recording medium 101 via the drive device 100. However, the program is not necessarily installed from the recording medium 101, and may be downloaded from another computer via a network. The auxiliary storage device 102 stores the installed program and also stores necessary files, data, and the like.

In a case where an instruction to start the program is received, the memory device 103 reads and stores the program from the auxiliary storage device 102. The CPU 104 implements a function related to the program generation device 10 in accordance with a program stored in the memory device 103. The interface device 105 is used as an interface for connecting to a network. The display device 106 displays a graphical user interface (GUI) or the like by the program. The input device 107 is constituted by a keyboard and a mouse, for example, and is used to input various operation instructions.

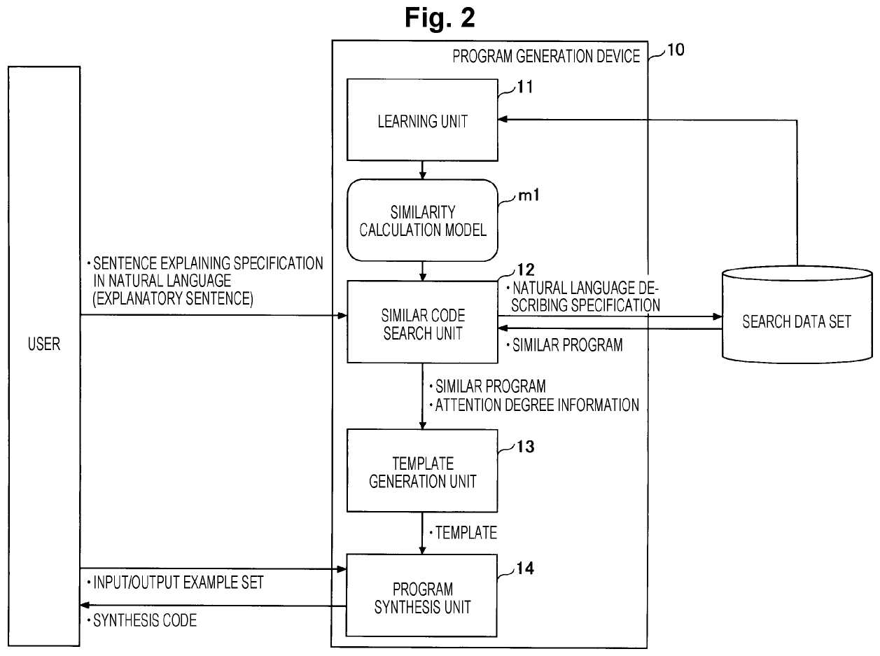

FIG. 2 is a diagram illustrating an example of a functional configuration of the program generation device 10 according to the embodiment of the present invention. In FIG. 2, the program generation device 10 includes a learning unit 11, a similar code search unit 12, a template generation unit 13, and a program synthesis unit 14. Each of these units is implemented by processing that one or more programs installed in the program generation device 10 cause the CPU 104 to execute.

Note that a similarity calculation model m1 in FIG. 2 is a model (neural network) that calculates a similarity between a sentence (explanatory sentence) explaining a specification of a program in a natural language and a source code of the program.

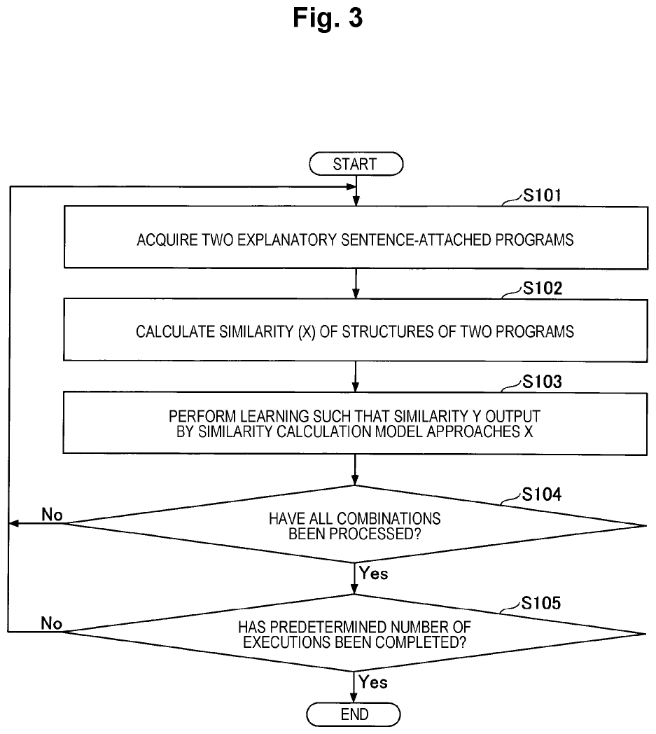

A processing procedure executed by the program generation device 10 will be described below. FIG. 3 is a flowchart for describing an example of a processing procedure of learning processing of the similarity calculation model m1.

In step S101, for example, the learning unit 11 randomly acquires two (two sets of) explanatory sentence-attached programs from a search data set stored in the auxiliary storage device 102.

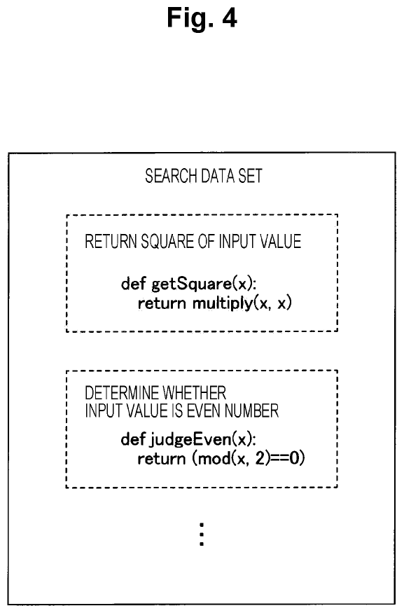

FIG. 4 is a diagram illustrating an example of a search data set. In FIG. 4, a unit surrounded by a broken line is one explanatory sentence-attached program. An explanatory sentence-attached program refers to data including a source code of the program and a sentence (explanatory sentence) explaining a specification of the program in a natural language (Japanese in the present embodiment) in association with each other. That is, the data structure of the search data set is described in a format based on Backus-Naur form (BNF) notation as follows.
<Search data set>::=[explanatory sentence source code]+

A plurality of explanatory sentence-attached programs are prepared in advance as search data sets. In step S101, two sets of explanatory sentence-attached programs are randomly acquired from a plurality of explanatory sentence-attached programs. However, in step S101 for the second and subsequent times, two sets other than the already acquired combination are acquired. In the learning processing of the similarity calculation model m1, the search data set is used as a learning data set of the similarity calculation model m1.

Subsequently, the learning unit 11 calculates a similarity (hereinafter referred to as a “similarity X”) of the structures of the source codes included in each of the two explanatory sentence-attached programs (S102). For example, Tree Edit Distance may be used as an index of the similarity X.

Subsequently, the learning unit 11 trains the similarity calculation model m1 (updates model parameters of the similarity calculation model m1) such that a cosine similarity (hereinafter referred to as a “similarity Y”) between the result of vectorization of the explanatory sentence of one of the two explanatory sentence-attached programs and the result of vectorization of the source code of the other explanatory sentence-attached program approaches the similarity X (for example, a difference between the similarity Y and the similarity X decreases) (S103). The similarity calculation model m1 can be realized using a model or the like used in a program search method or the like using a deep learning model. The model is detailed in “Yao Wan, Jingdong Shu, Yulei Sui, Guandong Xu, Zhou Zhao, Jian Wu, and Philip S. Yu. Multi-modal attention network learning for semantic source code retrieval. In Proceedings of the 34th IEEE/ACM International Conference on Automated Software Engineering, ASE '19, p. 13 {25. IEEE Press, 2019. URL: https://dl.acm.org/doi/abs/10.1109/ASE.2019.00012”.

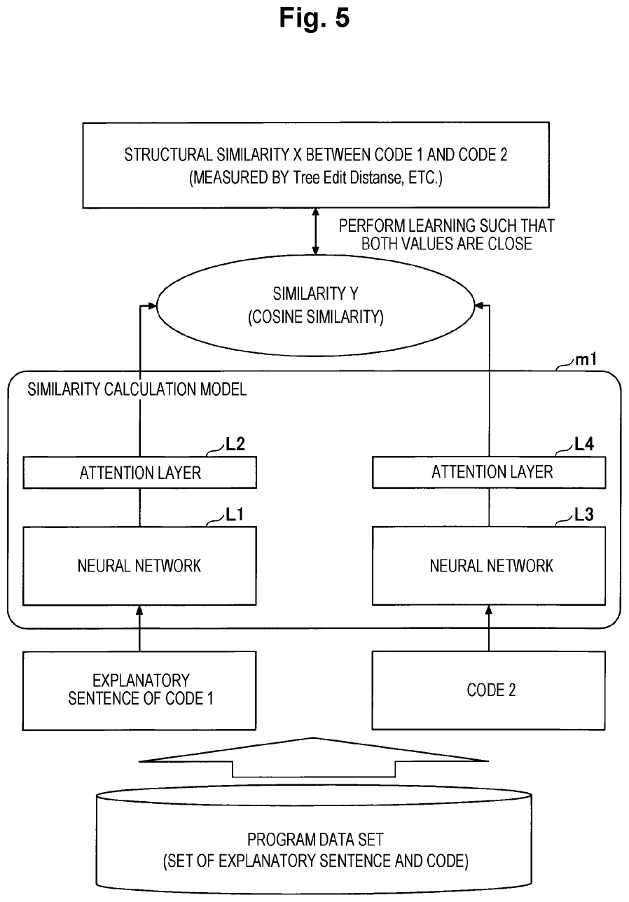

FIG. 5 is a diagram for describing learning of the similarity calculation model m1. As illustrated in FIG. 5, the similarity calculation model m1 includes a neural network L1, an attention layer L2, a neural network L3, an attention layer L4, and the like.

The neural network L1 is a neural network that converts each word of the explanatory sentence into a vector (hereinafter referred to as a “vector v1”) having a predetermined number of dimensions (for example, 512 dimensions). For example, when the explanatory sentence includes J words, J vectors v1 are output from the neural network L1.

The attention layer L2 is a neural network that receives J vectors v1 as inputs and outputs one vector (hereinafter referred to as a “vector v2”). The attention layer L2 weights each vector v1 by the weight parameter of the attention layer L2 to generate one vector v2.

The neural network L2 is a neural network that converts each token of the source code into a vector (hereinafter referred to as a “vector v3”) having a predetermined number of dimensions (for example, 512 dimensions). For example, when the explanatory sentence includes K tokens, K vectors v2 are output from the neural network L2.

The attention layer L4 is a neural network that receives K vectors v3 as inputs and outputs one vector (hereinafter referred to as a “vector v4”). The attention layer L4 weights each vector v1 and each vector v3 by the weight parameter of the attention layer L4 to generate one vector v4. Among the weights in the weighting, the weight for each vector v3 corresponds to the attention degree for each token of the source code in the calculation of the vector v4 (eventually, in the calculation of the similarity Y).

In step S103, the learning unit 11 trains the neural network L1, the neural network L2, the attention layer L3, and the attention layer L4 such that the cosine similarity (similarity Y) between the vector v2 and the vector v4 approaches the similarity X.

Subsequently, the learning unit 11 determines whether or not step S101 and the subsequent steps have been executed for all two sets of the explanatory sentence-attached program in the search data set (S104). In a case where there are two unprocessed sets (No in S104), step S101 and the subsequent steps are repeated. At this time, in step S101, two sets of explanatory sentence-attached programs other than the two sets that have already been set as processing targets are acquired.

When step S101 and subsequent steps are executed for all two sets (Yes in S104), the learning unit 11 determines whether the number of executions of steps S101 to S104 has reached a predetermined number of epochs (S105). In a case where the number of executions is less than the predetermined number of epochs (No in S105), step S101 and the subsequent steps are repeated for all combinations. In a case where the number of executions reaches the predetermined number of epochs (Yes in S105), the learning unit 11 ends the learning of the similarity calculation model m1. Note that a learning end condition may be set for a learning convergence situation (for example, a difference between the similarity X and the similarity Y) of the similarity calculation model m1.

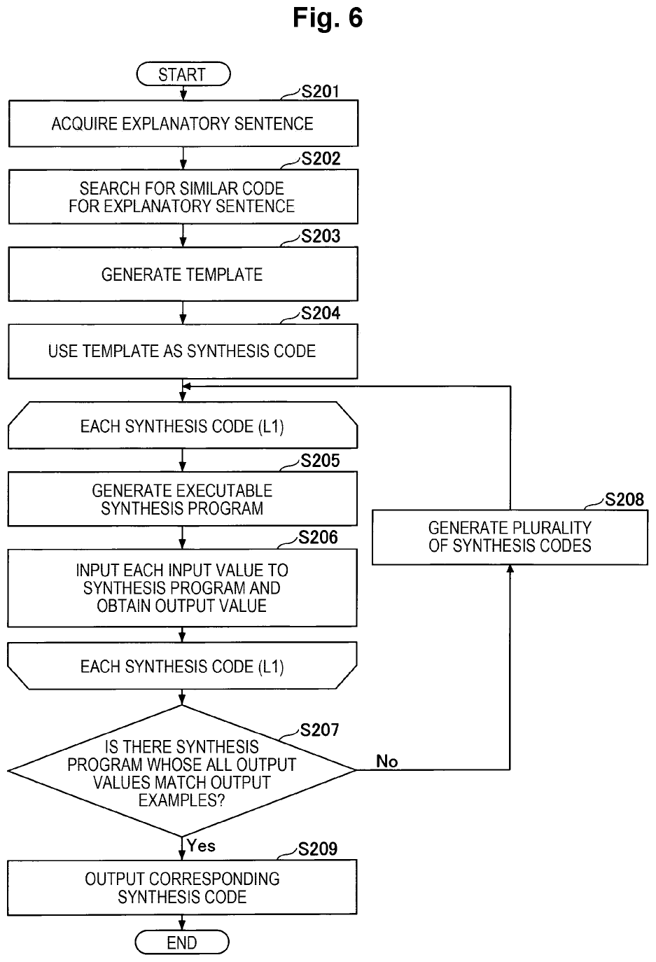

When the learning of the similarity calculation model m1 ends, the processing procedure of FIG. 6 can be executed. FIG. 6 is a flowchart for describing an example of a processing procedure of automatic generation processing of a program.

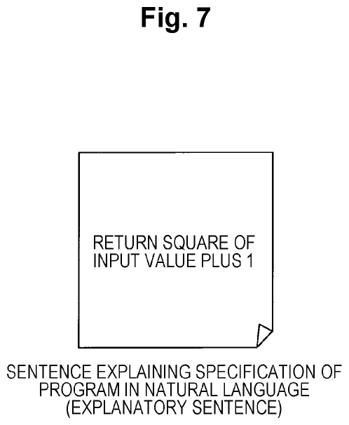

In step S201, the similar code search unit 12 acquires a sentence (hereinafter referred to as a “target explanatory sentence”) in which specifications of a desired (generation target) program (hereinafter referred to as a “target program”) are described in a natural language. The target explanatory sentence may be input at the timing of step S201, or may be stored in advance in the auxiliary storage device 102 or the like. FIG. 7 illustrates an example of the target explanatory sentence.

Subsequently, the similar code search unit 12 uses the trained similarity calculation model m1 to search for a source code (hereinafter referred to as a “similar code”) having a relatively high similarity Y with the target explanatory sentence from the search data set (S202). Specifically, the similar code search unit 12 calculates the similarity Y between each source code included in the search data set and the target explanatory sentence using the similarity calculation model m1, and specifies source codes with the similarity Y in the top S (S≥1) as similar codes. Note that, in the process of calculating the similarity Y, the attention degree to each token of the source code for which the similarity Y is to be calculated is calculated by the attention layer L4 of the similarity calculation model m1. For each similar code, the similar code search unit 12 outputs the similar code and attention degree information indicating the attention degree of each token of the similar code.

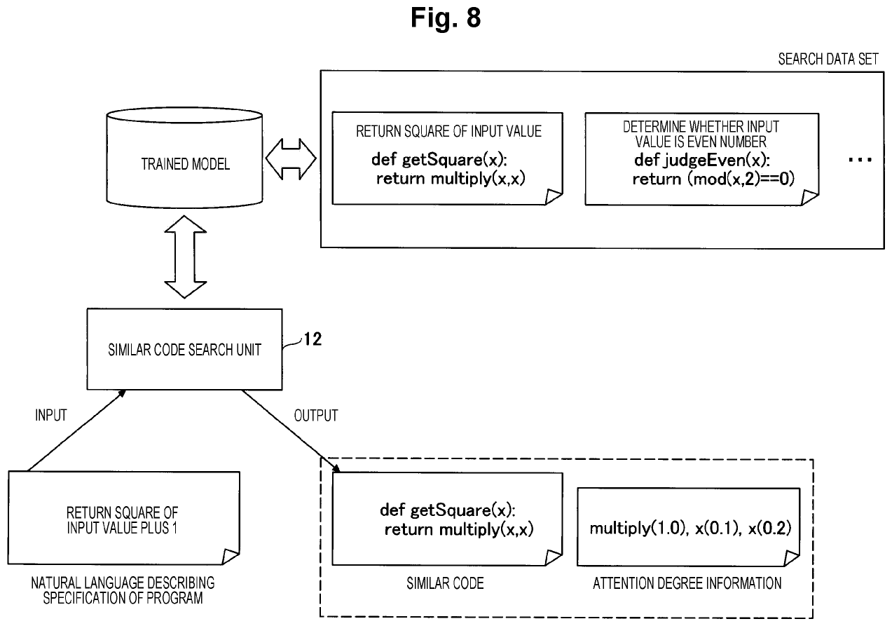

FIG. 8 is a diagram illustrating a state of searching for a similar code. The format of the attention degree information is described in the format based on the BNF notation as follows.
<Attention degree information>::=[token attention degree]+

In the example of FIG. 8, the attention degree information is information in which the attention degree in the range of 0 to 1 is assigned to each token in the format of “(attention degree)”.

Note that, in step S202, the explanatory sentence of each explanatory sentence-attached program of the search data set is not used. Therefore, the search target in step S202 may not be the same data set as that at the time of learning, and the search in step S202 may be performed on a simple set of source codes of the program.

Subsequently, the template generation unit 13 generates, as a template, a source code in which a token having an attention degree equal to or higher than a threshold value in the similar code is set as a fixed portion (S203). In a case where a plurality of similar codes are searched for, a plurality of templates are generated.

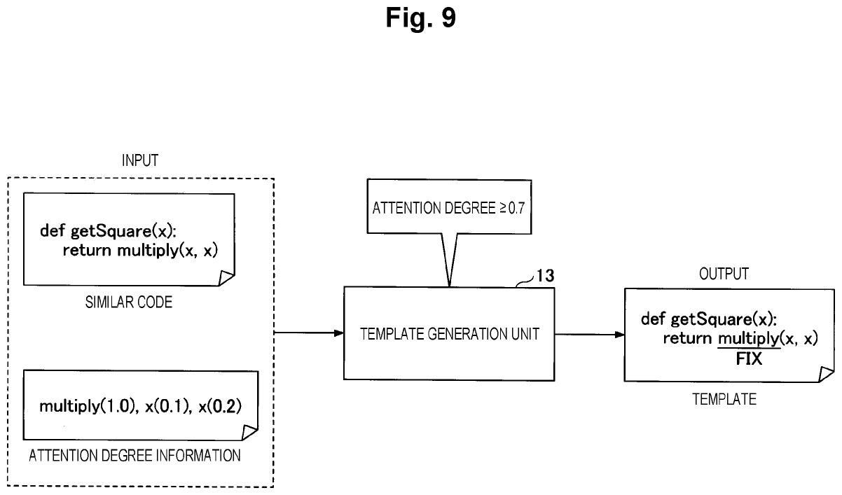

FIG. 9 is a diagram illustrating an example of generating a template. FIG. 9 illustrates an example of generating a template in a case where the threshold value for the attention degree is 0.7. In this case, “multiply” is fixed in the generated template. A format of the template based on the BNF notation is as follows.
<Template>::=[fixed token or non-fixed token]+

In FIG. 9, an underlined portion corresponds to a fixed token, and the other portions correspond to non-fixed tokens. Note that whether or not the token is a fixed token may be identified by a method other than underlining.

Subsequently, the program synthesis unit 14 uses each template generated by the template generation unit 13 as a synthesis code (S204), and executes loop processing L1 including steps S205 and S206 for each synthesis code. Hereinafter, the synthesis code to be processed in the loop processing L1 will be referred to as a “target code”.

In step S205, the program synthesis unit 14 compiles and links the target code to generate an executable program (hereinafter referred to as a “synthesis program”).

Subsequently, the program synthesis unit 14 inputs each input/output example included in the input/output example set to the synthesis program (hereinafter referred to as a “target synthesis program”) to execute the target synthesis program, and obtains an output for each input/output example (S206).

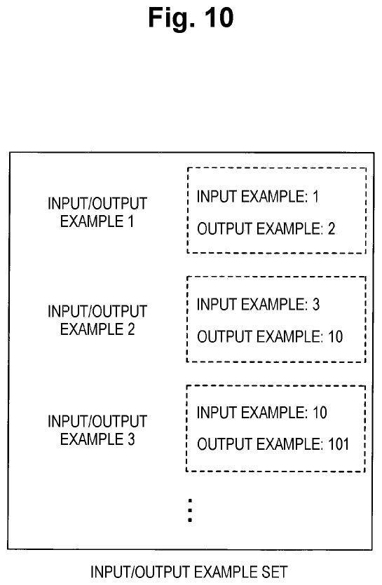

FIG. 10 is a diagram illustrating an example of an input/output example set. The input/output example set is information indicating a condition that the target program should satisfy regarding input/output. Each input/output example of the input/output example set includes a value of an input to the target program and a value of an output to be output by the target program with respect to the input. The data structure of the input/output example set is described in a format based on the BNF notation as follows.

$$< Input / output example set > \text{::} = < input / output example > + < Input / output example > \text{::} = < input example > < output example >$$

$$< Input Example > \text{::} = input value + < Output example > \text{::} = output value +$$

That is, the input/output example set includes one or more input/output examples. One input/output example is a set of an input example and an output example. The input example refers to one or more input values, and the output example refers to one or more output values.

For example, in a case where the number of input/output examples included in the input/output example set is M, the program synthesis unit 14 executes the target synthesis program with the input value as an input for each of the M input values in step S206, and obtains M output values.

When the loop processing L1 ends, the program synthesis unit 14 determines the presence or absence of a synthesis program that satisfies all the input/output examples (S207). That is, it is determined whether or not there is a synthesis program in which all the output values obtained in step S206 are as expected (correct) among the synthesis programs to be processed in the loop processing L1.

In a case where there is no corresponding synthesis program (No in S207), the program synthesis unit 14 generates a plurality of (for example, N) synthesis codes on the basis of one template by, for example, randomly selecting one or more program components in a program component list prepared in advance and stored in the auxiliary storage device 102 and synthesizing the selected program components with a portion (non-fixed token) not fixed in the template (by replacing the non-fixed token with the program component) (S208).

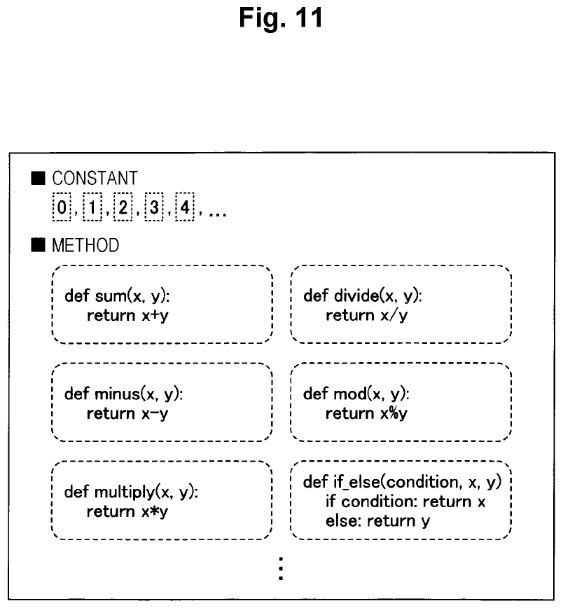

FIG. 11 is a diagram illustrating an example of the program component list. A data structure of the program component list illustrated in FIG. 11 is described in a format based on the BNF notation as follows.

<Program component list>::=program component+

That is, the program component list includes (the source code of) one or more program components. In FIG. 11, program components are classified into constants and methods. Here, one constant corresponds to one program component, and one method corresponds to one program component. That is, a unit surrounded by a broken line in FIG. 11 corresponds to a unit of one program component.

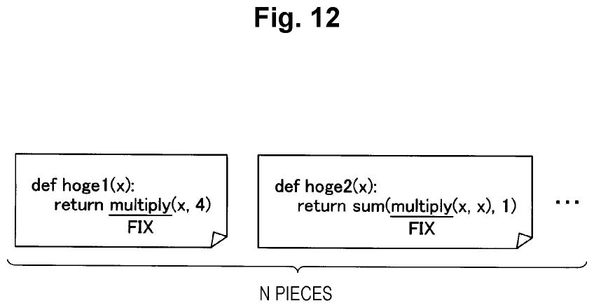

FIG. 12 is a diagram illustrating an example of a synthesis code generated using a template. Each synthesis code in FIG. 12 includes the fixed token illustrated in FIG. 9. In other words, a new synthesis code is generated by synthesizing the fixed token and the program component.

Note that the synthesis of program components means that calculations of a plurality of program components are combined, and can be performed using a known technique such as genetic programming, for example. For example, each program component is expressed by a tree structure having an operator as a parent node and a variable, a constant, or an operator to be operated by the operator as a child node, and a node of the tree structure of any program component is replaced with a tree structure of another program component, so that these program components can be synthesized. Note that the synthesis code includes a definition in which a value is input, calculation related to the input value is executed, and a calculation result of the value is output, similarly to the program component.

Subsequently, the program synthesis unit 14 repeats the loop processing L1 and subsequent steps.

On the other hand, when the synthesis program satisfying all the input/output examples is generated (Yes in S207), the program synthesis unit 14 outputs the synthesis code related to the synthesis program as the source code of the target program (S209). In the present embodiment, the second synthesis code (hoge2) in FIG. 12 is output as the source code satisfying the input/output example in FIG. 10.

As described above, according to the present embodiment, the synthesis code is generated on the basis of the source code similar to the explanatory sentence of the desired specification. Further, a program component is synthesized with an important token having a high contribution (high attention degree) to the similarity in the source code to generate a synthesis code. Therefore, important tokens can be prevented from being lost during synthesis, and as a result, a probability that a desired program is generated can be improved.

In the present embodiment, the similar code search unit 12 is an example of a calculation unit. The program synthesis unit 14 is an example of a generation unit.

Although the embodiment of the present invention has been described in detail above, the present invention is not limited to such a specific embodiment, and various modifications and changes can be made within the scope of the gist of the present invention described in the claims.

### REFERENCE SIGNS LIST

10 Program generation device
11 Learning unit
12 Similar code search unit
13 Template generation unit
14 Program synthesis unit
100 Drive device
101 Recording medium
102 Auxiliary storage device
103 Memory device
104 CPU
105 Interface device
106 Display device
107 Input device
B Bus

1. A program generation device comprising a processor configured to execute operations comprising:
calculating, for a plurality of first source codes, a similarity between the first source code and a sentence explaining a specification of a desired program in a natural language;
calculating an attention degree of each token constituting the first source code in calculation of the similarity; and
automatically generating a plurality of synthesis codes by synthesizing a token having a relatively high attention degree among the first source codes having a relatively high similarity with a second source code prepared in advance.

2. The program generation device according to claim 1, wherein the calculating the similarity further comprises calculating the similarity between the sentence explaining the specification of the desired program in the natural language and the first source code and the attention degree of each token constituting the first source code by using a neural network, and the neural network calculates a similarity between a sentence explaining a specification of a program in a natural language and a source code of the program and an attention degree of each token constituting the source code in calculation of the similarity.

3. The program generation device according to claim 2, further comprising:
training the neural network such that the similarity calculated by the neural network for a sentence of first learning data and a source code of second learning data in a set of learning data including a set of a source code of a program and a sentence explaining a specification of the program in a natural language approaches a predetermined similarity between the source code of the first learning data and the source code of the second learning data.

4. A method for generating a program, the method comprising:
calculating, for a plurality of first source codes, a similarity between the first source code and a sentence explaining a specification of a desired program in a natural language;
calculating an attention degree of each token constituting the first source code in calculation of the similarity; and
automatically generating a plurality of synthesis codes by synthesizing a token having a relatively high attention degree among the first source codes having a relatively high similarity with a second source code prepared in advance.

5. The method according to claim 4, wherein the calculating the similarity further comprises calculating the similarity between the sentence explaining the specification of the desired program in the natural language and the first source code and the attention degree of each token constituting the first source code by using a neural network, and the neural network calculates a similarity between a sentence explaining a specification of a program in a natural language and a source code of the program and an attention degree of each token constituting the source code in calculation of the similarity.

6. The method according to claim 5, further comprising:
training the neural network such that the similarity calculated by the neural network for a sentence of first learning data and a source code of second learning data in a set of learning data including a set of a source code of a program and a sentence explaining a specification of the program in a natural language approaches a predetermined similarity between the source code of the first learning data and the source code of the second learning data.

7. A computer-readable non-transitory recording medium storing computer-executable program instructions that when executed by a processor cause a computer to execute operations comprising:
calculating, for a plurality of first source codes, a similarity between the first source code and a sentence explaining a specification of a desired program in a natural language;
calculating an attention degree of each token constituting the first source code in calculation of the similarity; and
automatically generating a plurality of synthesis codes by synthesizing a token having a relatively high attention degree among the first source codes having a relatively high similarity with a second source code prepared in advance.

8. The program generation device according to claim 1, wherein the neural network represents a similarity calculation model, and the similarity calculation model includes a first set of neural networks to generate a first vector based on each word in the sentence.

9. The program generation device according to claim 8, wherein the similarity calculation model further includes a second set of neural networks to generate a second vector based on each token in the first source codes.

10. The program generation device according to claim 9, wherein the similarity is based on a cosine similarity between the first vector and the second vector.

11. The program generation device according to claim 1, wherein the automatically generated plurality of synthesis codes represents an executable code.

12. The method according to claim 4, wherein the neural network represents a similarity calculation model, and the similarity calculation model includes a first set of neural networks to generate a first vector based on each word in the sentence.

13. The method according to claim 4, wherein the automatically generated plurality of synthesis codes represents an executable code.

14. The method according to claim 12, wherein the similarity calculation model further includes a second set of neural networks to generate a second vector based on each token in the first source codes.

15. The method according to claim 14, wherein the similarity is based on a cosine similarity between the first vector and the second vector.

16. The computer-readable non-transitory recording medium according to claim 7, wherein the calculating the similarity further comprises calculating the similarity between the sentence explaining the specification of the desired program in the natural language and the first source code and the attention degree of each token constituting the first source code by using a neural network, and the neural network calculates a similarity between a sentence explaining a specification of a program in a natural language and a source code of the program and an attention degree of each token constituting the source code in calculation of the similarity.

17. The computer-readable non-transitory recording medium according to claim 16, the computer-executable program instructions when executed further causing the computer to execute operations comprising:
training the neural network such that the similarity calculated by the neural network for a sentence of first learning data and a source code of second learning data in a set of learning data including a set of a source code of a program and a sentence explaining a specification of the program in a natural language approaches a predetermined similarity between the source code of the first learning data and the source code of the second learning data.

18. The computer-readable non-transitory recording medium according to claim 7, wherein the neural network represents a similarity calculation model, and the similarity calculation model includes a first set of neural networks to generate a first vector based on each word in the sentence.

19. The computer-readable non-transitory recording medium according to claim 18, wherein the similarity calculation model further includes a second set of neural networks to generate a second vector based on each token in the first source codes.

20. The computer-readable non-transitory recording medium according to claim 19, wherein the similarity is based on a cosine similarity between the first vector and the second vector.
